(19) United States
(12) Patent Application Publication
(10) Pub. No.: US 2012/0255929 A1
(43) Pub. Date: Oct. 11, 2012

(54) ETCHING SOLUTION COMPOSITION FOR TRANSPARENT CONDUCTIVE FILM

(75) Inventors: Takao Yamaguchi, Soka-shi (JP); Norio Ishikawa, Soka-shi (JP)

(73) Assignee: Kanto Kagaku Kabushiki Kaisha, Tokyo (JP)

(21) Appl. No.: 13/444,294

(22) Filed: Apr. 11, 2012

(30) Foreign Application Priority Data
Apr. 11, 2011 (JP) 2011-087012

(51) Int. Cl. C09K 13/08; H01B 13/00; C09K 13/00

(52) U.S. Cl. 216/13; 252/79.1; 252/79.3

(57) ABSTRACT

The present invention provides an etching solution composition for etching crystalline transparent conductive films which enables etching of a crystalline ITO film without damaging copper and/or copper alloy used in electrode materials. Etching solution compositions for etching crystalline transparent conductive films described herein consist of an aqueous solution that comprises 1-10 wt % of a fluorine compound.

### TECHNICAL FIELD

The present invention relates to an etching solution composition for transparent conductive films used for electrodes in display devices of flat panel displays (FPDs), solar cells, and touch panels. More specifically, the present invention relates to an etching solution composition for transparent conductive films for touch panels composed of an organopolymeric film such as polyethylene terephthalate (PET) as a substrate, and a transparent conductive film and a copper and/or copper alloy film.

### BACKGROUND OF THE INVENTION

A transparent conductive film is a light-transmissive conductive material used for FPDs such as liquid crystal displays (LCDs) and electroluminescence displays (ELDs), solar cells, and touch panels. In these transparent conductive films, indium tin oxide, indium oxide, tin oxide, and zinc oxide are used, and in particular, indium tin oxide (hereinafter, referred to as ITO) is widely used.

Conventionally, as an ITO film, an amorphous ITO film formed on a glass substrate or plastic substrate is mainly used due to its workability such as ease of etching. Meanwhile, because crystalline ITO films have advantages such as low resistance, good electrical properties and high durability, they have been demanded in the field of flat panel display, etc.; however, since crystallization of ITO requires heat treatment at high temperature for a long period of time, film formation on a polymer-material substrate such as polyethylene terephthalate (PET) with low heat resistance is difficult, so that crystalline ITO films have not been widely used. In recent years however, it has become possible to form a crystalline ITO film on a polymer-material substrate, and therefore demand for crystalline ITO films has been increasing.

In order to use a transparent conductive film as a FPD display electrode, and an electrode for solar cells and touch panels, etc., it is necessary to form a film with film quality suitable for each electronic device, and to process the film into predetermined pattern shape. Etching by photolithography is performed as a patterning method; for example, an ITO film is formed on a glass substrate or plastic substrate, etc., by means of sputtering, etc., then the ITO film is etched using a mask such as a resist to obtain the ITO film having a desired pattern shape. Then, onto the ITO film as the electrode material, a copper and/or copper alloy film is applied as a wiring material.

Conventionally, as an etching solution for ITO films, a mixed solution consisting of hydrochloric acid and ferric chloride, a mixed solution consisting of hydrochloric acid and nitric acid (aqua regia), as well as hydroiodic acid and an oxalic acid solution are used. However, since these etching solutions have the following problems, they are not practically sufficient as an etching solution for ITO films that have a copper and/or copper alloy film as a wiring material, for example ITO films for touch panel use.

In Patent Literature 1, an etching method using a mixed solution consisting of hydrochloric acid and ferric chloride is proposed. This etching method is inexpensive and etching rate is high; however, it has a disadvantage that the etching solution comprises a metal (iron) that adversely influences semiconductors. In addition, damage to copper and/or copper alloy is large.

With a mixed solution of hydrochloric acid and nitric acid (aqua regia), the amount of side etching is large, chemical stability is low, and time-course change is significant. Accordingly, delivery of this solution is difficult. In addition, damage to copper and/or copper alloy used for an electrode wiring material is large.

With hydroiodic acid, the amount of side etching is small and etching properties are superior; however, it is expensive, and chemical stability is poor because iodine is easily released.

In Patent Literature 2, an etching method using an oxalic acid solution is proposed. An oxalic acid solution is inexpensive and has good chemical stability, and the amount of side etching is low. In addition, it does not cause much damage to copper and/or copper alloy used as an electrode wiring material; thus, this method has many superior points. However, an oxalic acid solution cannot be used for crystalline ITO films, because the films have a strong chemical resistance and they do not dissolve in oxalic acid solution. Therefore, the use of oxalic acid solution is limited to amorphous ITO films.

In Patent Literature 3, an etching method by an etching solution for ITO films using a fluorine compound is proposed, wherein the solution for etching consists of a chelate compound having an oxalic acid and two or more phosphonate groups in the molecule and a compound having a SO₃ group in the molecule, and the solution also comprises an aqueous fluorine compound. This method aims to improve removal of etching residues, and the use is limited to the etching of amorphous ITO films; accordingly, this method cannot be used for etching crystalline ITO films.

In Patent Literature 4, an etching solution to simultaneously etch silver and ITO is proposed; however, this solution comprises hydrogen fluoride and nitric acid, so that damage to copper cannot be avoided; therefore, this solution cannot be used for films containing copper and/or copper alloy.

In Patent Literature 5, an etching solution for crystalline transparent conductive films is disclosed, and a combination of hydrofluoric acid and inorganic acid is described. However, a practically sufficient etching rate for ITO films cannot be obtained; and because the reaction between hydrofluoric acid and inorganic acid occurs, there is a problem such as, for example with the etching solution using hydrofluoric acid and calcium chloride described in Table 2 of this literature, calcium fluoride precipitates and unwanted residues are generated. In this literature, since there is a description that etching is performed by oxalic acid, it is considered that the above-mentioned crystalline transparent conductive films practically means either amorphous ones, or crystalline ones with only a very low crystallinity.

### CITATION LIST

### Patent Literature

[Patent Literature 1] JP A 2009-231427
[Patent Literature 2] JP A 5-62966
[Patent Literature 3] JP A 2005-197397
[Patent Literature 4] JP A 2009-206462
[Patent Literature 5] JP A 2002-299326

### SUMMARY OF THE INVENTION

The aim of the present invention is to solve the above conventional problems, and to provide an etching solution composition for transparent conductive films, which enables etching of amorphous and crystalline ITO films, in particular crystalline ITO films, without damage to copper and/or copper alloy used as an electrode material.

The inventors of the present invention have devoted themselves to solve the above problems, and found that an etching solution composition for crystalline transparent conductive films, consisting of an aqueous solution that comprises a fluorine compound, enables etching of amorphous and crystalline ITO films without damage to copper and/or copper alloy used as an electrode wiring material. Furthermore, by making the above etching solution composition for etching crystalline transparent conductive films comprising an oxidizing agent, in particular perchloric acid, the inventors found that it is possible to increase etching rate without damage to copper and/or copper alloy; after further research, the inventors have accomplished the present invention.

Namely, the present invention relates to the following.
[1] An aqueous etching solution composition for etching a crystalline transparent conductive film comprising 1-10 wt % of a fluorine compound.
[2] The aqueous etching solution composition for etching a crystalline transparent conductive film according to [1], wherein the crystalline transparent conductive film is a crystalline indium tin oxide (ITO) film in which (222) peak of In₂O₃ is detected by X-ray diffraction method.
[3] The aqueous etching solution composition for etching a crystalline transparent conductive film according to [1] or [2], wherein the crystalline transparent conductive film is formed by annealing at 250° C. or more.
[4] The aqueous etching solution composition for etching a crystalline transparent conductive film according to any one of [1] to [3], wherein the crystalline transparent conductive film is a crystalline indium tin oxide (ITO) film that does not dissolve in oxalic acid.
[5] The aqueous etching solution composition for etching a crystalline transparent conductive film according to any one of [1] to [4], wherein the crystalline transparent conductive film is a crystalline ITO film comprising copper and/or copper alloy.
[6] The aqueous etching solution composition for etching a crystalline transparent conductive film according to any one of [1] to [5], wherein the aqueous solution does not comprise nitric acid and calcium chloride.
[7] The aqueous etching solution composition for etching a crystalline transparent conductive film according to any one of [1] to [6], further comprising perchloric acid.
[8] The aqueous etching solution composition for etching a crystalline transparent conductive film according to any one of [1] to [7], wherein the fluorine compound comprises one or more compounds selected from hydrogen fluoride, ammonium fluoride, sodium fluoride, potassium fluoride, ammonium hydrogen fluoride, sodium hydrogen fluoride, tetrafluorosilicon, hexafluorosilicic acid, hexafluorosilicate, fluoroboric acid, and fluoborate.
[9] The aqueous etching solution composition for etching a crystalline transparent conductive film according to [8], wherein the fluorine compound is hydrogen fluoride.
[10] The aqueous etching solution composition for etching a crystalline transparent conductive film according to any one of [1] to [9], further comprising an aromatic polysulfonic acid or a salt thereof as a surfactant.
[11] A method for etching a crystalline ITO film, wherein the crystalline ITO film comprising a copper and/or copper alloy film is formed on a substrate, the method comprising a step of etching the crystalline ITO film using the etching solution composition according to any one of [1] to [10].
[12] The method according to [11], wherein the crystalline ITO film is one in which (222) peak of In₂O₃ is detected by X-ray diffraction method.
[13] The method according to [11] or [12], wherein the crystalline ITO film is formed by annealing at 250° C. or more.
[14] The method according to anyone of [11] to [13], wherein the crystalline transparent conductive film is a crystalline indium tin oxide (ITO) film that does not dissolve in oxalic acid.
[15] A method for etching a crystalline ITO film used for touch panels, wherein the crystalline ITO film comprising a copper and/or copper alloy film is formed on a substrate, the method comprising a step of etching the crystalline ITO film using the etching solution composition according to any one of [1] to [10].
[16] The method according to [15], wherein the crystalline ITO film is one in which (222) peak of In₂O₃ is detected by X-ray diffraction method.
[17] The method according to [15] or [16], wherein the crystalline ITO film is formed by annealing at 250° C. or more.
[18] The method according to anyone of [15] to [17], wherein the crystalline transparent conductive film is a crystalline indium tin oxide (ITO) film that does not dissolve in oxalic acid.

By means of the etching solution composition for crystalline transparent conductive films and the etching treatment method of the present invention, it becomes possible to etch transparent conductive films with high accuracy in an etching-rate controlled manner, without generating etching residues and by-products.

### BRIEF DESCRIPTION OF THE DRAWINGS

FIG. 1 is a diagram showing XRD pattern of samples produced with annealing temperature (substrate temperature) of 100-300° C.

### DETAILED DESCRIPTION OF CERTAIN EMBODIMENTS

The present invention relates to an etching solution composition for etching crystalline transparent conductive films, consisting of an aqueous solution that comprises 1-10 wt% of a fluorine compound.

Examples of transparent conductive films useful in the present invention include, but are not limited to, those of indium tin oxide, indium oxide, tin oxide, and zinc oxide. In certain embodiments, transparent conductive films used in the present invention are ITO films, and the etching solution composition of the present invention is particularly suitable for etching crystalline ITO films, but the composition can also etch amorphous ITO films.

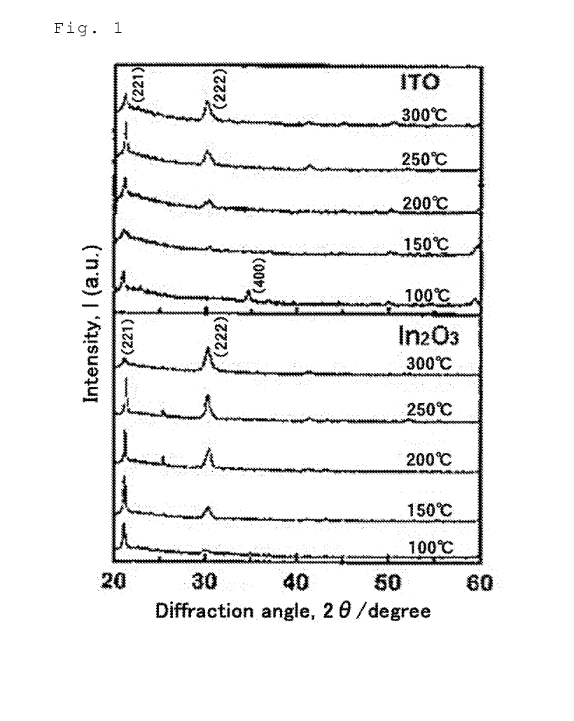

In the present invention, crystalline ITO films are those which satisfy any one of the following conditions: (a) a film wherein (222) peak of In₂O₃ is detected by X-ray diffraction method (refer to FIG. 1), (b) a film formed by annealing at 250° C. or higher, and (c) a film that does not dissolve in oxalic acid. A film that satisfies two of the above (a)-(c) is preferred, and a film that satisfies all of (a)-(c) is further preferred.

Furthermore, because the etching solution composition of the present invention can etch without corroding copper and/or copper alloy, it is particularly suitable for etching crystalline ITO films comprising copper and/or copper alloy.

Exemplary fluorine compounds used in the etching solution composition for crystalline conductive transparent films of the present invention include, but are not limited to, hydrogen fluoride, ammonium fluoride, sodium fluoride, potassium fluoride, ammonium hydrogen fluoride, sodium hydrogen fluoride, tetrafluorosilicon, hexafluorosilicic acid, hexafluorosilicate, fluoroboric acid, fluoborate, etc. In certain embodiments, the fluorine compound is ammonium fluoride or hydrogen fluoride. Ammonium fluoride and hydrogen fluoride have an extensive record of use in electronics applications and are low cost. In certain embodiments, the fluorine compound is hydrogen fluoride.

The concentration of a fluorine compound used in an etching solution composition for crystalline conductive transparent films of the present invention is 0.1-10.0 wt %. In certain embodiments, it is 1.0-5.0 wt %. When the concentration of the fluorine compound is less than 0.1 wt %, the etching rate is low and non-practical. When the concentration exceeds 10.0 wt %, obtainable effect is not sufficient for the concentration, which is not economically acceptable. In addition, damage to glass used as a base material of FPDs, etc. is large.

In one embodiment of the present invention, the etching solution composition for etching crystalline conductive transparent films of the present invention does not comprise nitric acid and calcium chloride. Since nitric acid corrodes copper and/or copper alloy formed on a transparent conductive film, it cannot be used for transparent conductive films having copper and/or copper alloy. In addition, calcium chloride generates a by-product by the reaction with a fluorine compound. For example, when hydrogen fluoride and calcium chloride are combined, calcium fluoride precipitates, which is not practically desirable. Moreover, the etching solution composition for transparent conductive films having this combination of substances is not able to etch crystalline ITO films.

In one embodiment of the present invention, by adding an oxidizing agent to the etching solution composition for crystalline conductive transparent films of the present invention, etching rate can be increased. Exemplary oxidizing agents include perchloric acid, nitric acid, hydrogen peroxide, etc. In certain embodiments, the oxidizing agent is perchloric acid, which does not damage copper and/or copper alloy. In the present invention, the concentration of an oxidizing agent is not particularly limited; when perchloric acid is used, the concentration of perchloric acid is 0.1-30.0 wt %. Preferably it is 1.0-20.0 wt %. When the concentration of perchloric acid is less than 0.1 wt %, there is no effect to increase etching rate. When the concentration exceeds 30.0 wt %, obtainable effect is not sufficient for the concentration, which is not economically acceptable.

In order to improve etching residue-removing characteristic, a surfactant may be added to the etching solution composition of the present invention. Examples of the surfactant include, but are not limited to, a naphthalene sulfonate formaldehyde condensate and salts thereof, polystyrene sulfonic acid and salts thereof, lignin sulfonic acid and salts thereof, polyethylene sulfonic acid and salts thereof, aromatic polysulfonic acid such as 1,5-naphthalene-disulfonic acid, 1-naphthol-3,6-disulfonic acid and salts thereof.

Examples of the naphthalene sulfonate formaldehyde condensate and salts thereof include those commercially available with a trade name of Polystar NP100 (NOF Corporation), Runox 1000, 1000C, 1500A (Toho Chemical Industry Co., Ltd.), Ionet D-2, Sanyo Levelon PHL (Sanyo Chemical Industries, Ltd.), Loma PWA-40 (SAN NOPCO Limited), Demol N, Demol AS (Kao Corporation). In addition, POLITY 1900 (Lion Corporation) as polystyrene sulfonic acid and its sodium salts, and SOLPOLE 9047K (Toho Chemical Industry Co., Ltd.) as lignin sulfonic acid and its sodium salts are commercially available.

When used for electronic industrial applications, those comprising a metal such as sodium are not preferred, and they can be used after removal of sodium by ion exchange resin, etc.

In certain embodiments, the temperature for using the etching solution composition for transparent conductive films of the present invention is 50° C. or less. In certain embodiments, the temperature is in the range of 20-45° C. In certain embodiments, the temperature is in the range of 25-40° C. When the temperature is higher than 50° C., the life of the solution decreases due to evaporation of components of the etching solution composition. When the temperature is lower than 20° C., practical etching rate cannot be obtained.

In another aspect, the present invention provides a method for etching a crystalline ITO film, wherein the crystalline ITO film comprising copper and/or copper alloy is formed on a substrate, the method comprising a step of etching the crystalline ITO film using an etching solution composition described herein.

Here, the substrate may be any substrate that can be used for semiconductor substrates, FPDs and touch panels, etc.; typical examples include glass, quartz, polyethylene terephthalate (PET), polyethersulfone (PES), etc. In particular, in touch panels wherein flexibility, transparency, toughness, chemical resistance, and electrical insulation property are required, organic polymer films such as polyethylene terephthalate (PET) and polyethersulfone (PES) are used as the substrate; and the present invention is suitable for etching a crystalline ITO film having copper and/or copper alloy formed on such organic polymer film substrate.

### EXAMPLES

Contents of the present invention are described in detail with reference to the following examples and comparative examples; however, the invention is not limited to these examples.

Table 1 shows composition of certain etching solution compositions of the present invention, and those of comparative etching solutions.

TABLE 1

| | Hydro- | | | | Hydro- | | |
|---|---|---|---|---|---|---|---|
| | chloric | Ferric | | Oxalic | fluoric | Ammonium | Perchloric |
| | acid | chloride | Nitric | acid | acid | fluoride | acid |
| | (%) | (III) (%) | acid (%) | (%) | (%) | (5) | (%) |
| Comp. | 18.0 | 4.0 | — | — | — | — | — |
| Ex. 1 | | | | | | | |
| Comp. | 18.0 | — | 4.0 | — | — | — | — |
| Ex. 2 | | | | | | | |
| Comp. | — | — | — | 3.4 | — | — | — |
| Ex. 3 | | | | | | | |
| Comp. | — | — | — | 3.4 | — | 0.01 | — |
| Ex. 4 | | | | | | | |
| Ex. 1 | — | — | — | — | 1.0 | — | |
| Ex. 2 | — | — | — | — | 1.0 | — | 3.0 |
| Ex. 3 | — | — | — | — | 2.0 | — | |
| Ex. 4 | — | — | — | — | 2.0 | — | 3.0 |
| Ex. 5 | — | — | — | — | 2.0 | — | 10.0 |
| Ex. 6 | — | — | — | — | 3.0 | — | |
| Ex. 7 | — | — | — | — | 3.0 | — | 3.0 |
| Ex. 8 | — | — | — | — | — | 3.0 | 10.0 |
| Ex. 9 | — | — | — | — | — | 3.0 | 20.0 |

With respect to the above etching solution compositions, the following experiments are conducted.

A PET substrate on which a crystalline ITO film is formed with a film thickness of 200 Å is prepared, and an etching test is performed by maintaining the temperature of an etching solution composition having a composition of Table 1 at 40° C. For calculating the etching rate, the etched substrate is washed with water and dried, then the time when the surface resistance at a tester becomes infinite is measured and etching rate (Å/min) is obtained by conversion using film thickness. Results are shown in Table 2.

With respect to damaging effect on copper, using a substrate on which copper with a film thickness of 3500 Å is formed, etching is performed by maintaining the temperature of the etching solution composition at 40° C.

Damaging effect is visually confirmed by presence/absence of copper in the etched product immersed for a predetermined time (60 min).

Results are shown in Table 2.

TABLE 2

| | Etching rate | Damaging effect on Cu |
|---|---|---|
| | (Å/min) | (60-min immersion) |
| Comparative Example 1 | 800 | X |
| Comparative Example 2 | 600 | X |
| Comparative Example 3 | — | ◯ |
| Comparative Example 4 | — | ◯ |
| Example 1 | 126 | ◯ |
| Example 2 | 150 | ◯ |
| Example 3 | 185 | ◯ |
| Example 4 | 240 | ◯ |
| Example 5 | 267 | ◯ |
| Example 6 | 300 | ◯ |
| Example 7 | 343 | ◯ |
| Example 8 | 185 | ◯ |
| Example 9 | 267 | ◯ |

—: Unable to etch
◯: No damage
X: Damaged (disappearance of Cu film)

−: Unable to etch
∘: No damage
×: Damaged (disappearance of Cu film)

In Comparative Examples 1 and 2 in which hydrochloric acid is contained in the etching solution, it is possible to etch the crystalline ITO film, but the copper film disappears.

In contrast, with the etching solution composition for etching crystalline transparent conductive films of the present invention, practical etching rate can be obtained without damaging the copper film.

Moreover, by changing the amount of perchloric acid, etching rate can be finely adjusted without damaging the copper film.

1. An aqueous etching solution composition for etching a crystalline transparent conductive film comprising 1-10 wt % of a fluorine compound.

2. The aqueous etching solution composition for etching a crystalline transparent conductive film according to claim 1, wherein the crystalline transparent conductive film is a crystalline indium tin oxide (ITO) film in which (222) peak of In₂O₃ is detected by X-ray diffraction method.

3. The aqueous etching solution composition for etching a crystalline transparent conductive film according to claim 1, wherein the crystalline transparent conductive film is formed by annealing at 250° C. or more.

4. The aqueous etching solution composition for etching a crystalline transparent conductive film according to claim 1, wherein the crystalline transparent conductive film is a crystalline indium tin oxide (ITO) film that does not dissolve in oxalic acid.

5. The aqueous etching solution composition for etching a crystalline transparent conductive film according to claim 1, wherein the crystalline transparent conductive film is a crystalline ITO film comprising copper and/or copper alloy.

6. The aqueous etching solution composition for etching a crystalline transparent conductive film according to claim 1, wherein the aqueous solution does not comprise nitric acid and calcium chloride.

7. The aqueous etching solution composition for etching a crystalline transparent conductive film according to claim 1, further comprising perchloric acid.

8. The aqueous etching solution composition for etching a crystalline transparent conductive film according to claim 1, wherein the fluorine compound comprises one or more compounds selected from hydrogen fluoride, ammonium fluoride, sodium fluoride, potassium fluoride, ammonium hydrogen fluoride, sodium hydrogen fluoride, tetrafluorosilicon, hexafluorosilicic acid, hexafluorosilicate, fluoroboric acid, and fluoborate.

9. The aqueous etching solution composition for etching a crystalline transparent conductive film according to claim 8, wherein the fluorine compound is hydrogen fluoride.

10. The aqueous etching solution composition for etching a crystalline transparent conductive film according to claim 1, further comprising an aromatic polysulfonic acid or a salt thereof as a surfactant.

11. A method for etching a crystalline ITO film, wherein the crystalline ITO film comprising a copper and/or copper alloy film is formed on a substrate, the method comprising a step of etching the crystalline ITO film using the etching solution composition according to claim 1.

12. The method according to claim 11, wherein the crystalline ITO film is one in which (222) peak of In₂O₃ is detected by X-ray diffraction method.

13. The method according to claim 11, wherein the crystalline ITO film is formed by annealing at 250° C. or more.

14. The method according to claim 11, wherein the crystalline transparent conductive film is a crystalline indium tin oxide (ITO) film that does not dissolve in oxalic acid.

15. A method for etching a crystalline ITO film used for touch panels, wherein the crystalline ITO film comprising a copper and/or copper alloy film is formed on a substrate, the method comprising a step of etching the crystalline ITO film using the etching solution composition according to claim 1.

16. The method according to claim 15, wherein the crystalline ITO film is one in which (222) peak of In₂O₃ is detected by X-ray diffraction method.

17. The method according to claim 15, wherein the crystalline ITO film is formed by annealing at 250° C. or more.

18. The method according to claim 15, wherein the crystalline transparent conductive film is a crystalline indium tin oxide (ITO) film that does not dissolve in oxalic acid.
